(19) United States
(12) Patent Application Publication
(10) Pub. No.: US 2004/0081485 A1
(43) Pub. Date: Apr. 29, 2004

(54) Variable open-size grid for improved charging subsystem uniformity and efficiency

(75) Inventors: Jing Qing Song, Webster, NY (US); John F. O'Brien, Fairport, NY (US); Ke Chun Tang, Shanghai (CN); Bruce E. Thayer, Webster, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/283,416

(22) Filed: Oct. 29, 2002

(51) Int. Cl. G03G 15/02

(52) U.S. Cl. 399/171

(57) ABSTRACT

A scorotron charging apparatus for producing a uniform charge on a charge retentive surface, comprising: corona producing means, spaced from the charge retentive surface, for emitting corona ions; and a grid, interposed between said corona producing means and the charge retentive surface, said grid having a first region of apertures disposed longitudinal with respect to the charge retentive surface and disposed substantially perpendicular to the direction of travel of the charge retentive surface, and a second region of apertures, adjacent to said first region of apertures, disposed longitudinal with respect to the charge retentive surface, said first region of apertures having an open area substantial higher than said second region of apertures.

### BACKGROUND AND SUMMARY OF THE INVENTION

This invention relates to a scorotron charging device, and more particularly, to a scorotron device that applies a uniform charge to a charge retentive surface.

Corona charging of xerographic photoreceptors has been disclosed as early as U.S. Pat. No. 2,588,699. It has always been a problem that current levels for practical charging require coronode potentials of many thousands of volts, while photoreceptors only need to be charged to several hundreds of volts. One attempt at controlling the uniformity and magnitude of corona charging is U.S. Pat. No. 2,777,957 which makes use of an open screen as a control electrode, to establish a reference potential, so that when the receiver surface reaches the screen voltage, the fields no longer drive ions to the receiver, but rather to the screen. Unfortunately, a low porosity screen intercepts most of the ions, allowing a very small percentage to reach the intended receiver. A more open screen, on the other hand, delivers charges to the receiver more efficiently, but compromises the control function of the device and thus the uniformity of final surface potential.

In accordance with the present invention, there is provided a scorotron charging apparatus adapted to apply a uniform charge to a charge retentive surface, which is more uniform that that obtained with simple scorotron grids.

### BRIEF DESCRIPTION OF THE DRAWINGS

FIG. 1 is a schematic elevational view of an illustrative electrophotographic printing or imaging machine or apparatus incorporating a charging apparatus having the features of the present invention therein.

FIG. 2 shows a typical voltage profile of an image area in the electrophotographic printing machines illustrated in FIG. 1 after that image area has been charged.

FIG. 3 shows a typical voltage profile of the image area after being exposed.

FIG. 4 shows a typical voltage profile of the image area after being developed.

FIG. 5 shows a typical voltage profile of the image area after being recharged by a first recharging device.

FIG. 6 shows a typical voltage profile of the image area after being exposed for a second time.

FIG. 7 is a front cross sectional view of an embodiment of the present invention.

FIG. 8 is a circuit schematic of a scorotron device of the present invention.

FIG. 9 is the current voltage profile of a charge device. The parameters, which is defined as the slope of the charging device, can be measured from the current voltage profile.

FIG. 10 is a graph illustrating expected voltage and charge profiles across the surface of the photoreceptor using a prior art scorotron device using a prior art grid of FIG. 14.

FIG. 11 is a graph illustrating experimental data that the device I-V slope increases as the hole diameter increases.

FIG. 12 is a graph illustrating experimental data on grid hole size impact on charging.

FIG. 13 is a graph illustrating experimental data on grid hole size impact on charging Standard Deviation at Low & High Frequency.

FIG. 14 is a top view of a prior art grid having a uniform distribution of open area.

FIG. 15 is a top view of a grid of the present invention having a variable distribution of open area.

FIG. 16 is a graph illustrating expected voltage and charge profiles across the surface of the photoreceptor using the scorotron device using a grid of FIG. 15 of the present invention.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENT

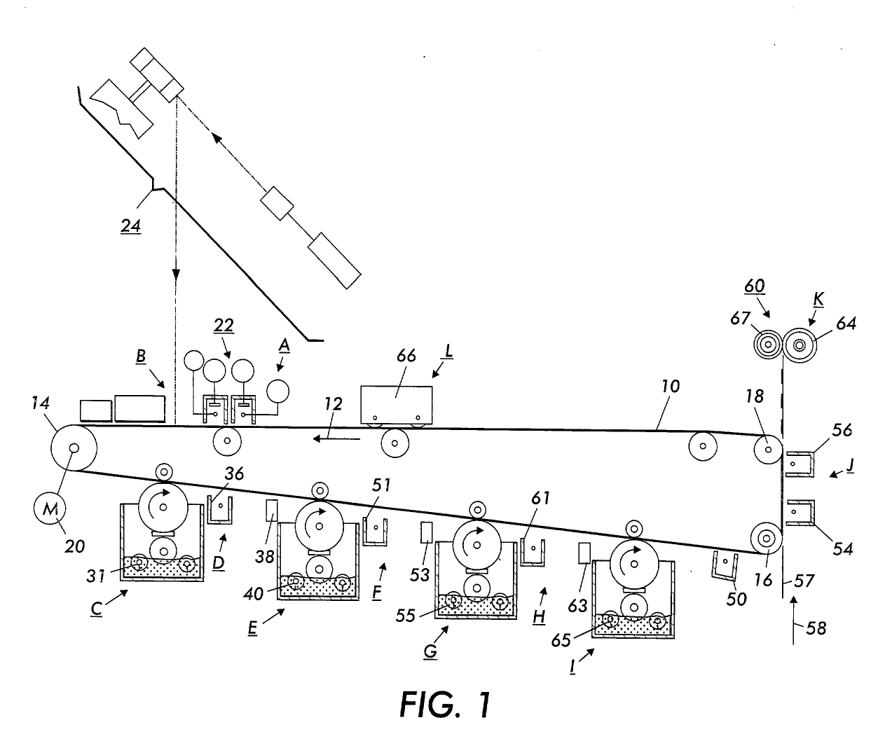

For a general understanding of the present invention, reference is made to the drawings. In the drawings, like reference numerals have been used throughout to designate identical elements. FIG. 1 shows a schematic elevational view of an electrophotographic printing machine incorporating the features of the present invention therein. It will become evident from the following discussion that the present invention is equally well suited for use in a wide variety of printing systems, and is not necessarily limited in its application to the particular system shown herein.

Referring initially to FIG. 1, there is shown an illustrative electrophotographic machine having incorporated therein the charging apparatus of the present invention. An electrophotographic printing machine 8 creates an image in a single pass through the machine and incorporates the features of the present invention. The printing machine 8 uses a charge retentive surface in the form of an Active Matrix (AMAT) photoreceptor belt 10, which travels sequentially through various process stations in the direction indicated by the arrow 12. Belt travel is brought about by mounting the belt about a drive roller 14 and two tension rollers 16 and 18 and then rotating the drive roller 14 via a drive motor 20.

As the photoreceptor belt moves, each part of it passes through each of the subsequently described process stations. For convenience, a single section of the photoreceptor belt, referred to as the image area, is identified. The image area is that part of the photoreceptor belt which is to receive the toner powder images which, after being transferred to a substrate, produce the final image. While the photoreceptor belt may have numerous image areas, since each image area is processed in the same way, a description of the typical processing of one image area suffices to fully explain the operation of the printing machine.

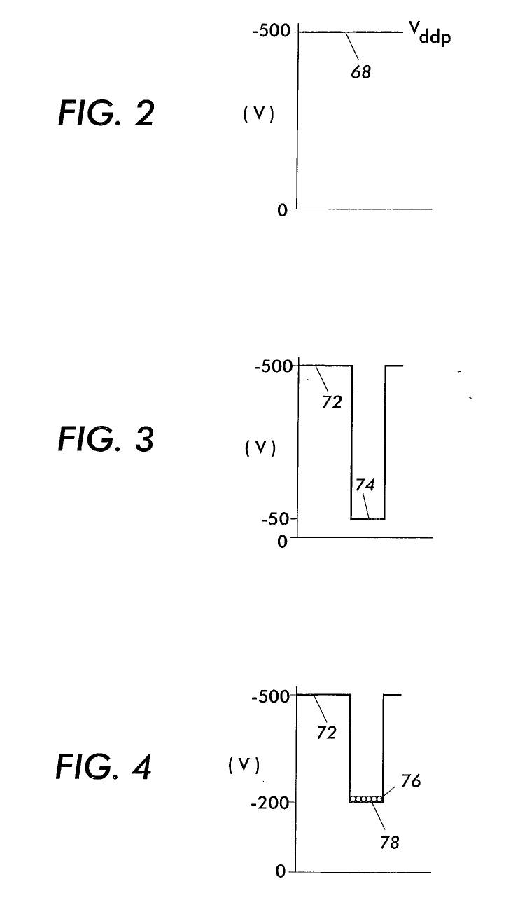

As the photoreceptor belt 10 moves, the image area passes through a charging station A. At charging station A, a corona generating device of the present invention is employed, indicated generally by the reference numeral 22, charges the image area to a relatively high and substantially uniform potential. FIG. 2 illustrates a typical voltage profile 68 of an image area after that image area has left the charging station A. As shown, the image area has a uniform potential of about −500 volts. In practice, this is accomplished by charging the image area slightly more negative than −500 volts so that any resulting dark decay reduces the voltage to the desired −500 volts. While FIG. 2 shows the image area as being negatively charged, it could be positively charged if the charge levels and polarities of the toners, recharging devices, photoreceptor, and other relevant regions or devices are appropriately changed.

After passing through the charging station A, the now charged image area passes through a first exposure station B. At exposure station B, the charged image area is exposed to light, which illuminates the image area with a light representation of a first color (say black) image. That light representation discharges some parts of the image area so as to create an electrostatic latent image. While the illustrated embodiment uses a laser based output scanning device 24 as a light source, it is to be understood that other light sources, for example an LED printbar, can also be used with the principles of the present invention. FIG. 3 shows typical voltage levels, the levels 72 and 74, which might exist on the image area after exposure. The voltage level 72, about −500 volts, exists on those parts of the image area which were not illuminated, while the voltage level 74, about −50 volts, exists on those parts which were illuminated. Thus after exposure, the image area has a voltage profile comprised of relative high and low voltages.

After passing through the first exposure station B, the now exposed image area passes through a first development station C, which is identical in structure with development systems E, G, and I. The first development station C deposits a first color, say black, of negatively charged toner 31 onto the image area. That toner is attracted to the less negative sections of the image area and repelled by the more negative sections. The result is a first toner powder image on the image area.

For the first development station C, the development system includes a donor roll, which develops the image on the photoconductive surface. FIG. 4 shows the voltages on the image area after the image area passes through the first development station C. Toner 76 (which generally represents any color of toner) adheres to the illuminated image area. This causes the voltage in the illuminated area to increase to, for example, about −200 volts, as represented by the solid line 78. The un-illuminated parts of the image area remain at level 72 about −500.

After passing through the first development station C, the now exposed and toned image area passes to a first recharging station D. The recharging station D is comprised of a corona recharging device, a recharging device 36 of the present invention, which acts to recharge the voltage levels of both the toned and intoned parts of the image area to a substantially uniform level.

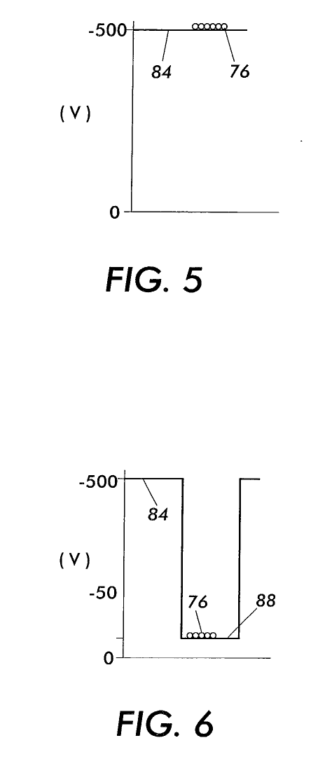

FIG. 5 shows the voltages on the image area after it passes through the recharging device 36. The recharging device charges the image area. Both the untoned parts and the toned parts (represented by toner 76) are recharged to a level 84 which is the desired potential of −500 volts, as shown in FIG. 5.

After being recharged at the first recharging station D, the now substantially uniformly charged image area with its first toner powder image passes to a second exposure station 38. Except for the fact that the second exposure station illuminates the image area with a light representation of a second color image (say yellow) to create a second electrostatic latent image, the second exposure station 38 is the same as the first exposure station B. FIG. 6 illustrates the potentials on the image area after it passes through the second exposure station. As shown, the non-illuminated areas have a potential about −500 as denoted by the level 84. However, illuminated areas, both the previously toned areas denoted by the toner 76 and the untoned areas are discharged to about −50 volts as denoted by the level 88.

The image area then passes to a second development station E. Except for the fact that the second development station E contains a toner 40 which is of a different color (yellow) than the toner 31 (black) in the first development station C, the second development station is substantially the same as the first development station. Since the toner 40 is attracted to the less negative parts of the image area and repelled by the more negative parts, after passing through the second development station E the image area has first and second toner powder images which may overlap.

The image area then passes to a second recharging station F. The second recharging station F has a recharging device, which operates similar to the recharging device 36. The now recharged image area then passes through a third exposure station 53. Except for the fact that the third exposure station illuminates the image area with a light representation of a third color image (say magenta) so as to create a third electrostatic latent image, the third exposure station 38 is the same as the first and second exposure stations B and 38. The third electrostatic latent image is then developed using a third color of toner 55 (magenta) contained in a third development station G.

The now recharged image area then passes through a third recharging station H. The third recharging station includes recharge device 61 which adjusts the voltage level of both the toned and untoned parts of the image area to a substantially uniform level in a manner similar to the recharging device 36 and recharging device 51.

After passing through the third recharging station the now recharged image area then passes through a fourth exposure station 63. Except for the fact that the fourth exposure station illuminates the image area with a light representation of a fourth color image (say cyan) so as to create a fourth electrostatic latent image, the fourth exposure station 63 is the same as the first, second, and third exposure stations, the exposure stations B, 38, and 53, respectively. The fourth electrostatic latent image is then developed using a fourth color toner 65 (cyan) contained in a fourth development station 1.

To condition the toner for effective transfer to a substrate, the image area then passes to a pre-transfer corona device 50 which delivers corona charge to ensure that the toner particles are of the required charge level and polarity so as to ensure proper subsequent transfer.

After passing the corona device 50, the toner powder images are transferred from the image area onto a support sheet 57 at transfer station J. It is to be understood that the support sheet is advanced to the transfer station in the direction 58 by a conventional sheet feeding apparatus, which is not shown. The transfer station J includes a transfer corona device 54, which sprays positive ions onto the backside of sheet 57. This causes the negatively charged toner powder images to move onto the support sheet 57. The transfer station J also includes a detack corona device 56 which facilitates the removal of the support sheet 52 from the printing machine 8.

After transfer, the support sheet 57 moves onto a conveyor (not shown), which advances that sheet to a fusing station K. The fusing station K includes a fuser assembly, indicated generally by the reference numeral 60, which permanently affixes the transferred powder image to the support sheet 57. Preferably, the fuser assembly 60 includes a heated fuser roller 67 and a backup or pressure roller 64. When the support sheet 57 passes between the fuser roller 67 and the backup roller 64 the toner powder is permanently affixed to the sheet support 57. After fusing, a chute, not shown, guides the support sheets 57 to a catch tray, also not shown, for removal by an operator. After the support sheet 57 has separated from the photoreceptor belt 10, residual toner particles on the image area are removed at cleaning station L via a cleaning brush 4 contained in a housing 66. The image area is then ready to begin a new marking cycle.

The various machine functions described above are generally managed and regulated by a controller which provides electrical command signals for controlling the operations described above.

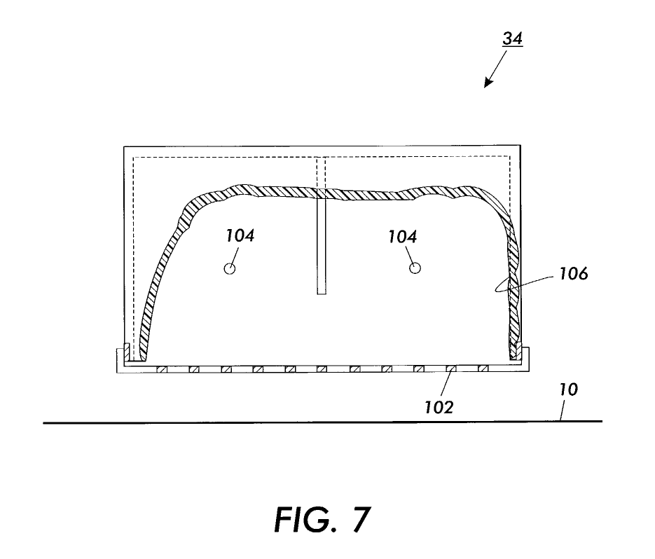

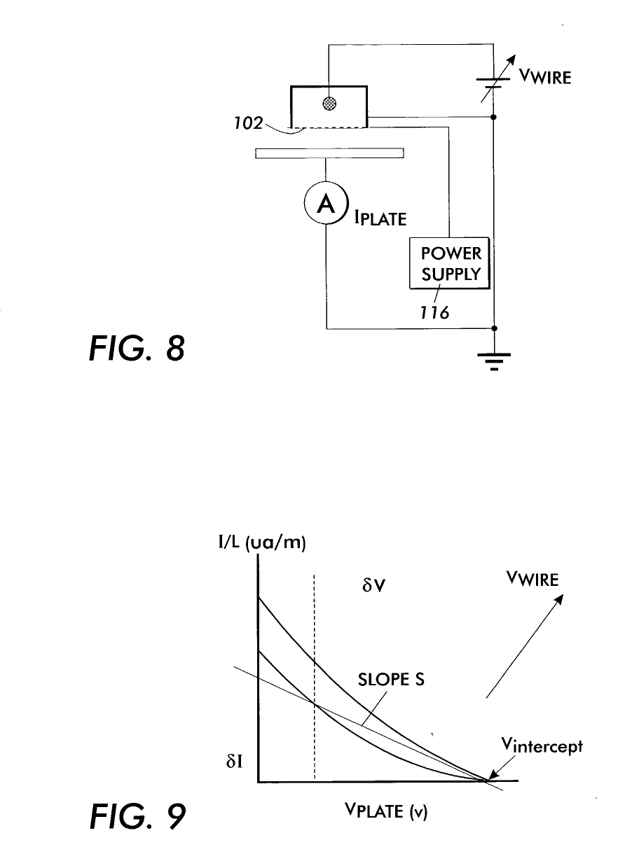

Referring now to FIG. 7, which depicts various portions of the scorotron of FIG. 1, scorotron 34 is comprised of a grid 102, and a corona generating element 104 usually enclosed within a U-shaped shield 106. For example, Grid 102 can be made from any flexible, conductive, perforated material, and is preferably formed from a thin metal film having a pattern of regularly spaced perforations opened therein, as illustrated in FIG. 7. As illustrated, corona generating elements 104 are commonly known wires or thin rod-like members as shown in the Figure. However, preferably a variety of comb-shaped pin arrangements are employed as the corona generating elements for pin scorotrons. The three primary elements of the scorotron 34, the grid, the shield, and the corona generating element, are maintained in electrical isolation from one another so as to prevent electrical current from flowing directly from one to another. More specifically, corona element mounts are used to electrically insulate the corona generating element from shield 106, as well as, to rigidly position corona element 104 with respect to the shield. Similarly, the grid, while being generally supported by or suspended from shield 106, is insulated therefrom by insulators, which form natural extensions of the legs of shield 106. Furthermore, the entire scorotron assembly, 34, is positioned in a direction parallel to the surface of photoreceptor belt 10, yet perpendicular to the direction of travel of the belt. As indicated by the simplified electrical schematic depicted in FIG. 8, the shield 106 is maintained at a high voltage potential by a power supply Vshield, and the corona element 104 is maintained at a high voltage potential by a power supply Vwire. Typically, the potential of the high voltage power supply is in the range of 1 to 10 kilovolts (kV), preferably at about 6 kV, thereby maintaining the corona element at a potential of about 6 kV and the shield in the range of about 0 to 1 kV. Likewise, grid 102 is also maintained at a predetermined voltage potential by high voltage supply 116, typically in the range of 0.3 kV to 1.5 kV, and preferably at about 0.6 kV. The shield may be biased to the same potential as the grid or to some other potential depending on the type of corona device being used.

The DC pin scorotron provides a low cost negative charging solution. However, ordinary pin scorotrons have certain limitations on the charging uniformity as currently implemented. Previous data showed a pin scorotron could maintain charging uniformity at ±25 volts for mid range process speeds. Note that pin scorotron chargers may or may not have a shield electrode.

Current and future electrophotographic printing machines have very high image quality requirements. The uniformity of charging of the charge retentive surface becomes an important issue in achieving these requirements. Based on a model of the system, the charging uniformity should be controlled within ±7 volts (two sigma) in order to achieve the image quality goals. This is a very challenging task since no previous products have achieved this goal by using DC pin scorotrons. Some alternative technologies are discorotrons and AC wire scorotrons. However, they are much more expensive than the DC pin scorotron and generate more noxious materials.

The function of the charging system is to deliver a certain level of voltage on the photoreceptor surface with a certain tolerance in the potential level. The uniformity goal is referred to as ΔVREQD. We typically use scorotrons to achieve high uniformity goals. The final charging uniformity can be estimated by using the following model.

(Vfinal−Vintercept)=(Vinitial−Vintercept)×exp(−s/cv) (equation 1)

Here Vintercept is a voltage close to the screen (grid) potential, Vgrid, where the charging current goes to zero. The overshoot is defined by the difference between Vintercept and Vgrid. Vinitial is the potential on the photoreceptor that has the largest difference from Vintercept as the photoreceptor enters the charging device. Parameter v is the speed of the moving photoreceptor. Parameter c is the capacitance per unit area of the photoreceptor. Parameter s is defined as the absolute value of the slope of the charging device of FIG. 9. It can be measured as shown in the previous graph of FIG. 8.

From equation 1, if the slope s is greater than cv, then it is clear that the final voltage approaches the intercept voltage more closely as the slope s increases. In reality, we design the device with a slope that is high enough so that (Vfinal−Vintercept) is less than the uniformity required for the highest grid potential and range in initial photoreceptor surface potentials expected to be used over the life of the photoreceptor.

The slope of a charging device is controlled by the chosen average value of current per unit length of coronode, the coronode to grid spacing, the grid hole size, the grid to photoreceptor surface spacing, and the percentage of the grid area that is open for the flow of ions from the coronode to the photoreceptor. To obtain high device slopes for higher speed applications, devices are designed with very porous grids where the percent open area is from 70 to 90 percent. However, highly porous grids tend to result in poor charging uniformity. In order to design a pin device that results in good charging uniformity, the design requires a low porosity grid where the percent open area is in the 40 to 70 percent range. Therefore, we have to balance the speed/slope and uniformity requirements.

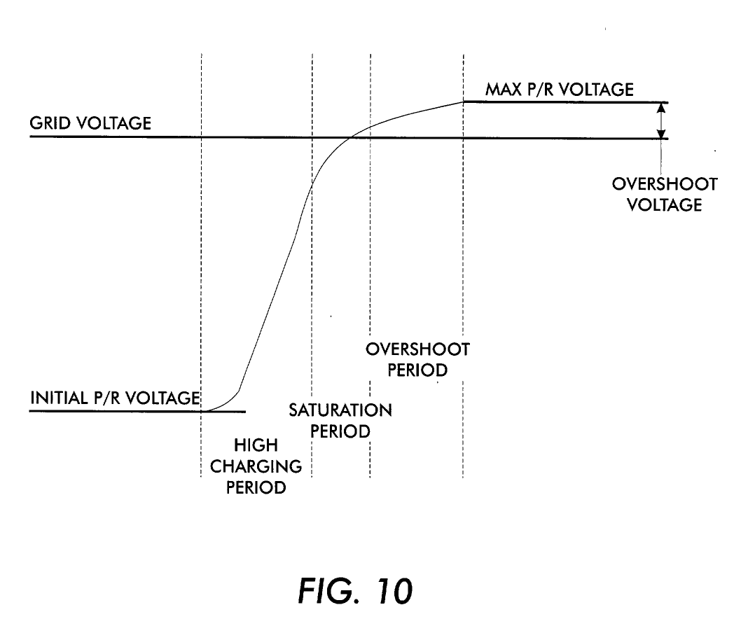

The ions generated from the coronodes are accelerated by the field force and pass the screen (grid) to reach the photoreceptor surface, thus increasing the surface potential. The change in the photoreceptor potential as it passes through the charging scorotron can be illustrated as the following graph of FIG. 10.

When the photoreceptor enters the scorotron, the initial photoreceptor potential is near 0. Therefore, the voltage difference between photoreceptor and grid is high. This generates a positive field to drive the ion flow to the photoreceptor surface. The charging efficiency is high so that the photoreceptor potential increases rapidly. We call this the high charging period.

As the photoreceptor potential nears the grid voltage, the field between the photoreceptor and grid is lower and the charging efficiency is significant reduced. Therefore, the voltage increases very slowly. This is the saturation period.

With the DC device, when the surface potential reaches the same voltage as the screen, there is no electrostatic field between the screen and photoreceptor. However, since the ions have a high residual momentum as they approach the grid from the coronode side, they will continue to penetrate the grid and build up a space charge. This extra space charge drives some ions to the photoreceptor surface. This increases the surface potential further until the repulsion field force is big enough to prevent further ion transport. We define the overshoot voltage (intercept votage) as the difference in photoreceptor surface potential above the screen voltage where the current goes to zero. We call this region the overshoot period.

We contend that we should design a charging system that ensures the final charging voltage is not in the high charging period, since small differences in local areas of the charging device can cause high voltage variations on the photoreceptor. Experimental data confirms our theory. High process speed means less charging time, therefore, it is more likely that the final voltage is still in the high charging period. Therefore we would have high voltage variations.

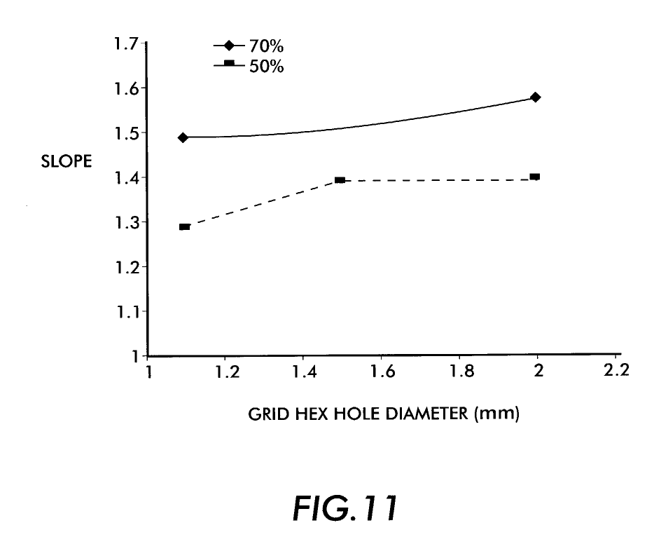

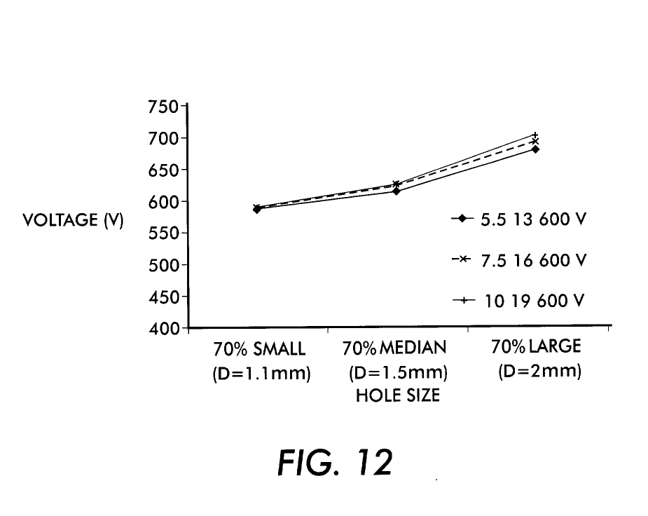

Tests show that grids with a higher percentage of open area or larger hole size have higher charging efficiency. The following of FIG. 11 graph shows that the device I-V slope increases as the hole diameter increases. The large percentage open area (70% to 85%) has higher slope than low percentage open area (50% to 70%). The following FIG. 12 shows that final charge potential increases as the hole diameter increases.

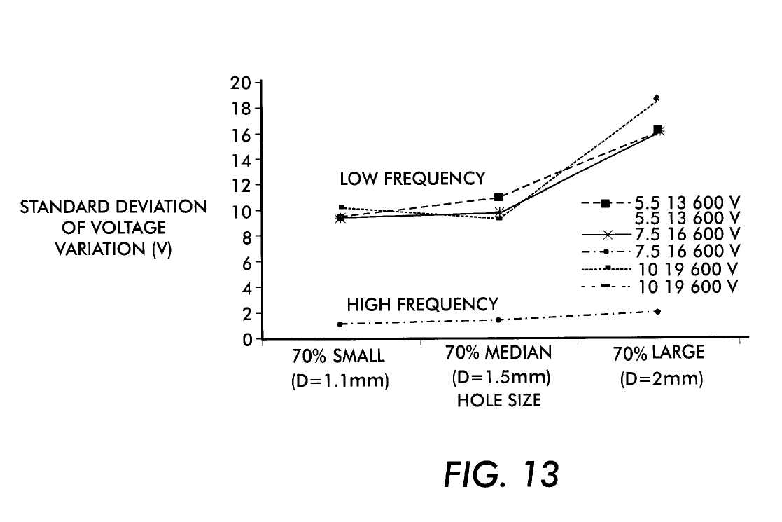

Data from charging uniformity measurements show that the average final voltage increases as the hole size increases. This also confirms our projection that large hole size improves the charging efficiency. However, the side effect of this improvement is that both low and high frequency variations in the final potential across the width of the device also increase. The graph of FIG. 13 shows the standard deviation of the low and high frequency voltage variations. It clearly shows the side effect of the large hole size.

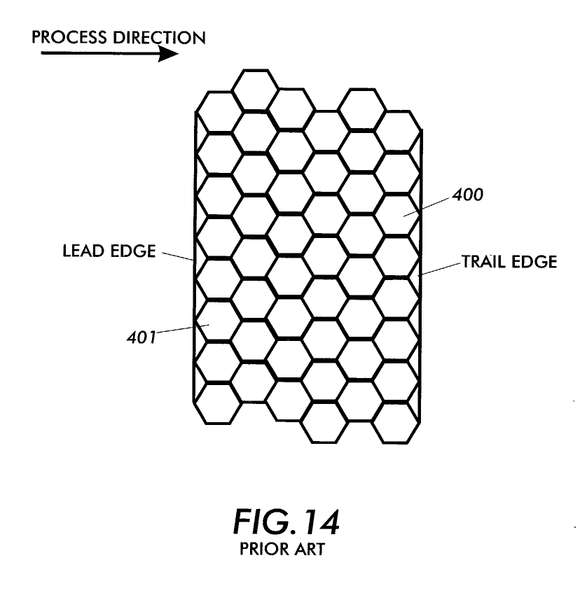

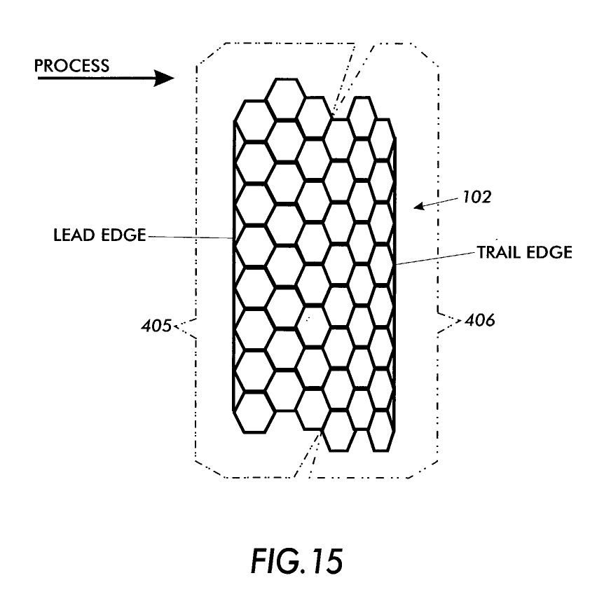

Typical grids currently used have a uniform hole size and percent open area over the entire grid, as shown in FIG. 14. Holes 400 and 401 in FIG. 14 have exactly the same size and shape. The grid of the present invention improves charging uniformity by having a higher percentage of open area and bigger hole size in the lead edge region 405 of the grid and smaller hole size and open area in the trail edge region 406 of the grid as shown in FIG. 15.

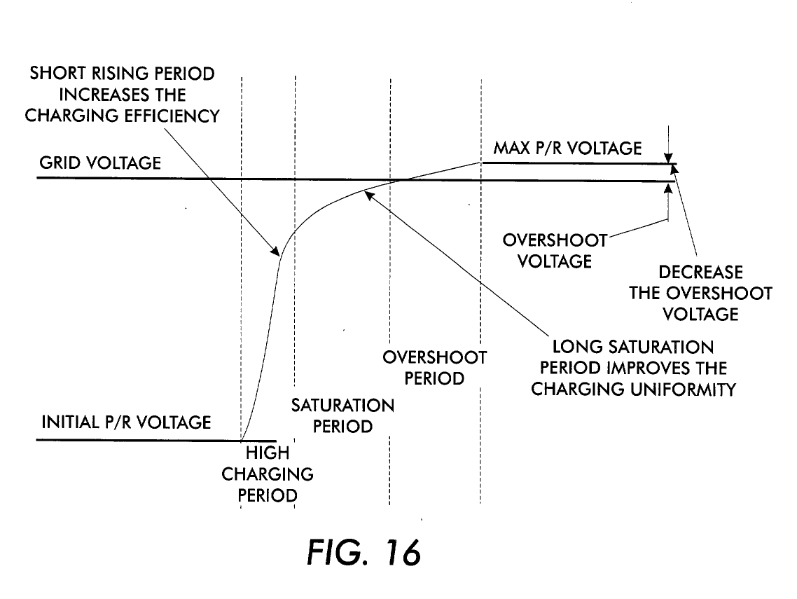

Therefore, the lead-edge of the device has a “higher” slope and higher charging efficiency. Therefore, the photoreceptor potential rises much faster as it passes under the lead edge of the corona device. The fast charging period is shorter and it takes less time to enter the saturation period. The low open area and small hole size makes the trail-edge of the device have a much “lower” slope. This is ideal for leveling the charging non-uniformity during the charging saturation period and the overshoot period. Areas of the photoreceptor having a somewhat lower voltage after going through the high charging area of the grid now will charge up faster than areas of the photoreceptor that were at a somewhat high voltage after passing through the higher charging area of the grid. The curvature of the charging curve in the overshoot region amplifies this effect. This grid design also effectively reduces the final overshoot voltage. The new grid design improves the charging process as shown in the following graph of FIG. 16.

While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

We claim:

1. A scorotron charging apparatus for producing a uniform charge on a charge retentive surface, comprising:
corona producing means, spaced from the charge retentive surface, for emitting corona ions; and
a grid, interposed between said corona producing means and the charge retentive surface, said grid having a first region of apertures disposed longitudinal with respect to the charge retentive surface and disposed substantially perpendicular to the direction of travel of the charge retentive surface, and a second region of apertures, adjacent to said first region of apertures, disposed longitudinal with respect to the charge retentive surface, said first region of apertures having an open area substantial higher than said second region of apertures.

2. The scorotron charging apparatus of claim 1, further comprising means for moving said charge retentive surface in a process direction relative to said scorotron.

3. The scorotron charging apparatus of claim 2, wherein said first region is associate with a lead edge portion said grid and said second region is associate with a trail edge portion said grid with respect to said process direction.

4. The scorotron charging apparatus of claim 1, wherein said open area of said first region is between 70% and 85%.

5. The scorotron charging apparatus of claim 1, wherein said open area of said second region is between 50% and 70%.

6. The scorotron charging apparatus of claim 1, further comprising means for maintaining said corona producing means at a first absolute voltage potential and said grid at a second absolute voltage potential, less than the first absolute voltage potential. The sign of the potentials depend on the desired sign of the desired current to be delivered to the charge retentive surface.

7. The scorotron charging apparatus of claim 1, wherein said grid comprises a perforated, electrically conductive film.

8. The scorotron charging apparatus of claim 1, wherein said corona producing means comprising a row or rows of pins.

9. The scorotron charging apparatus of claim 1, wherein said corona producing means comprising a wire or wires.

10. The scorotron charging apparatus of claim 1, wherein said corona producing means comprising a glass coated wire or wires.
